(19) United States
(12) Patent Application Publication
(10) Pub. No.: US 2026/0366095 A1
(43) Pub. Date: Nov. 19, 2026

(54) NON-ORIENTED ELECTRICAL STEEL SHEET AND METHOD FOR MANUFACTURING THE SAME

(71) Applicant: POSCO CO., LTD, Gyeongsangbuk-do, Pohang-si, (KR)

(72) Inventors: Jaewan Hong, Pohang-si, Gyeongsangbuk-do (KR); Sangwoo Lee, Pohang-si, Gyeongsangbuk-do (KR)

(73) Assignee: POSCO CO., LTD, Gyeongsangbuk-do, Pohang-si, (KR)

(21) Appl. No.: 19/132,327

(22) PCT Filed: Dec. 13, 2024
(86) PCT No.: PCT/KR2024/020324

§ 371 Date: May 22, 2025

(30) Foreign Application Priority Data
Dec. 15, 2023 (KR) 10-2023-0183892

(51) Int. Cl. C21D 9/46; C21D 8/1216; C21D 8/1244; C21D 8/1277; C22C 38/00; C22C 38/02; C22C 38/04; C22C 38/06; C22C 38/14; C22C 38/60

(52) U.S. Cl. CPC C21D 9/46; C21D 8/1222; C21D 8/1233; C21D 8/1261; C21D 8/1272; C21D 8/1277; C22C 38/001; C22C 38/002; C22C 38/008; C22C 38/02; C22C 38/04; C22C 38/06; C22C 38/14; C22C 38/60

(57) ABSTRACT

An exemplary embodiment of the present disclosure provides a non-oriented electrical steel sheet comprises, in weight %, Si: 1.5 to 5.0%, Al: 0.1 to 2.0%, Mn: 0.1 to 2.0%, with a remainder of Fe and unavoidable impurities, and satisfies the following Equation 1.

V{001}<001>/V{011}<001>≤0.65 [Equation 1]

(In Equation 1, V{001}<001> represents the fraction of grains with a crystal orientation within 15° of {001}<001>, and V{011}<001> represents the fraction of grains with a crystal orientation within 15° of {011}<001>.)

### TECHNICAL FIELD

An embodiment of the present invention relates to a non-oriented electrical steel and its manufacturing method. Specifically, an embodiment of the present invention provides a non-oriented electrical steel and a manufacturing method that maximizes magnetic anisotropy by developing a specific texture through heating, first soaking, second soaking, and cooling processes in a recrystallization annealing process after preliminary cold rolling.

### BACKGROUND ART

A non-oriented electrical steel is primarily used in motors that convert electrical energy into mechanical energy. In this process, excellent magnetic properties of non-oriented electrical steel are required to achieve high efficiency. Recently, as eco-friendly automobiles driven by motors instead of internal combustion engines have garnered attention, the demand for non-oriented electrical steel used as core material for drive motors has increased. For this purpose, non-oriented electrical steel with both excellent magnetic properties and strength is required.

The magnetic properties of non-oriented electrical steel are mainly evaluated based on core loss and magnetic flux density. Core loss refers to the energy loss occurring at a specific magnetic flux density and frequency, while magnetic flux density indicates the degree of magnetization obtained under a specific magnetic field. Lower core loss allows for the manufacture of motors with higher energy efficiency under the same conditions, and higher magnetic flux density enables motor miniaturization or reduction of copper loss. Therefore, by using non-oriented electrical steel with low core loss and high magnetic flux density, it is possible to create drive motors with excellent efficiency and torque, thereby improving the driving range and output of eco-friendly automobiles.

The characteristics of non-oriented electrical steel to be considered vary depending on the operating conditions of the motor. A general standard for evaluating the characteristics of non-oriented electrical steel used in motors is the core loss W15/50 under a 1.5 T magnetic field at a commercial frequency of 50 Hz. However, in non-oriented electrical steel with a thickness of 0.35 mm or less used in drive motors for eco-friendly automobiles, low magnetic fields of 1.0 T or below and high frequencies above 400 Hz are often important for magnetic properties. Therefore, the magnetic characteristics of non-oriented electrical steel are often evaluated using core loss W_{10/400}.

Recently, as non-oriented electrical steel is used for drive motors in electric vehicles, attempts to maximize magnetic anisotropy to increase motor output have continued, rather than achieving generally desired uniform magnetic properties. When magnetic anisotropy is maximized, the motor output increases, thereby improving overall efficiency. In this case, magnetic anisotropy means a large difference in magnetic flux density measured in the rolling direction and in a direction at a 45° angle to the rolling direction.

### DISCLOSURE

### Technical Problem

An embodiment of the present invention provides non-oriented electrical steel and its manufacturing method. Specifically, an embodiment of the present invention provides non-oriented electrical steel and a manufacturing method that maximizes magnetic anisotropy by developing a specific aggregate structure through heating, first soaking, second soaking, and cooling processes in a recrystallization annealing process after preliminary cold rolling.

An embodiment of the present invention provides non-oriented electrical steel and its manufacturing method. Specifically, an embodiment of the present invention provides non-oriented electrical steel and a manufacturing method that maximizes magnetic anisotropy by developing a specific aggregate structure through heating, first cracking, second cracking, and cooling processes in a recrystallization annealing process after preliminary cold rolling.

### Technical Solution

An exemplary embodiment of the present disclosure provides a non-oriented electrical steel sheet comprises, in weight %, Si: 1.5 to 5.0%, Al: 0.1 to 2.0%, Mn: 0.1 to 2.0%, with a remainder of Fe and unavoidable impurities, and satisfies the following Equation 1.

V{001}<001>/V{011}<001>≤0.65 [Equation 1]

(In Equation 1, V{001}<001> represents the fraction of grains with a crystal orientation within 15° of {001}<001>, and V{011}<001> represents the fraction of grains with a crystal orientation within 15° of {011}<001>.)

The non-oriented electrical steel according to an embodiment of the present invention may satisfy the following Equation 2.

(V{100}<001>+V{100}<031>+V{100}<110>)/(V{111}<112>+V{111}<011>)≥1.3 [Equation 2]

(In Equation 2, V{100}<001> represents the fraction of grains with a crystal orientation within 15° of {100}<001>, V{100}<031> represents the fraction of grains with a crystal orientation within 15° of {100}<031>, V{100}<110> represents the fraction of grains with a crystal orientation within 15° of {100}<110>, V{111}<112> represents the fraction of grains with a crystal orientation within 15° of {111}<112>, and V{111}<011> represents the fraction of grains with a crystal orientation within 15° of {111}<011>.)

The non-oriented electrical steel according to an embodiment of the present invention may further comprise at least one of P: 0.1 weight % or less (excluding 0%), C: 0.005 weight % or less (excluding 0%), S: 0.005 weight % or less (excluding 0%), Ti: 0.005 weight % or less (excluding 0%), N: 0.005 weight % or less (excluding 0%).

The non-oriented electrical steel according to an embodiment of the present invention may further comprise one or two or more of Sn, Sb, Bi, Pb, Ge, and As, each or in combination, at 0.005 to 0.200 weight %.

The non-oriented electrical steel according to an embodiment of the present invention may further comprise one or more of Cu: 0.005 to 0.2 weight %, Cr: 0.01 to 0.5 weight %, Ni: 0.05 weight % or less (excluding 0%), Zn: 0.01 weight % or less (excluding 0%), and Co: 0.05 weight % or less (excluding 0%).

The non-oriented electrical steel according to an embodiment of the present invention may further comprise one or more of Mo: 0.03 weight % or less (excluding 0%), B: 0.0050 weight % or less (excluding 0%), V: 0.0050 weight % or less (excluding 0%), Ca: 0.0050 weight % or less (excluding 0%), Nb: 0.0050 weight % or less (excluding 0%), Zr: 0.005 weight % or less (excluding 0%), Te: 0.01 weight % or less (excluding 0%), and Mg: 0.0050 weight % or less (excluding 0%).

The non-oriented electrical steel according to an embodiment of the present invention may satisfy the following Equation 3.

B_{50L}−B_{50D}≥0.08T [Equation 3]

(In Equation 3, B_{50L} represents the magnetic flux density B₅₀ measured in the rolling direction, and B_{50D} represents the magnetic flux density B₅₀ measured in a direction at a 45° angle to the rolling direction.)

The non-oriented electrical steel according to an embodiment of the present invention may satisfy the following Equation 4.

B_{50C}−B_{50D}≥0.03T [Equation 4]

(In Equation 4, B_{50C} represents the magnetic flux density B₅₀ measured in the direction perpendicular to the rolling direction, and B_{50D} represents the magnetic flux density B₅₀ measured in a direction at a 45° angle to the rolling direction.)

The non-oriented electrical steel according to an embodiment of the present invention may satisfy the following Equation 5.

(B₅₀L+B_{50C})/2≥1.68T [Equation 5]

(In Equation 5, B_{50L} represents the magnetic flux density B₅₀ measured in the rolling direction, and B_{50C} represents the magnetic flux density B₅₀ measured in the direction perpendicular to the rolling direction.)

Another exemplary embodiment of the present disclosure provides a method for manufacturing a non-oriented electrical steel sheet including: hot rolling a slab comprising, in weight %, Si: 1.5 to 5.0%, Al: 0.1 to 2.0%, Mn: 0.1 to 2.0%, with a remainder of Fe and unavoidable impurities to produce a hot-rolled sheet; preliminarily cold rolling the hot-rolled sheet; first annealing the preliminarily cold-rolled sheet; cold rolling the annealed sheet to produce a cold-rolled sheet; and second annealing the cold-rolled sheet.

The first annealing step includes heating the cold-rolled sheet from 40 °C to a first soaking temperature (T₁) at a rate of 10 to 50 °C/s; first soaking the cold-rolled sheet at the first soaking temperature (T₁) of 950 to 1100 °C; second soaking the cold-rolled sheet at a second soaking temperature (T₂) of 800 to 950 °C; and cooling from the second soaking temperature (T₂) to 670 °C for 10 to 40 seconds.

The first annealing step comprises heating the cold-rolled sheet from 40 °C to a first cracking temperature (T₁) at a rate of 10 to 50 °C/s; performing a first cracking of the cold-rolled sheet at the first cracking temperature (T₁) of 950 to 1100 °C; performing a second cracking of the cold-rolled sheet at a second cracking temperature (T₂) of 800 to 950 °C; and cooling from the second cracking temperature (T₂) to 670 °C for 10 to 40 seconds.

The slab may further comprise at least one of P: 0.1 weight % or less (excluding 0%), C: 0.005 weight % or less (excluding 0%), S: 0.005 weight % or less (excluding 0%), Ti: 0.005 weight % or less (excluding 0%), and N: 0.005 weight % or less (excluding 0%).

The slab may further comprise one or two or more of Sn, Sb, Bi, Pb, Ge, and As, each or in combination, at 0.005 to 0.200 weight %.

The slab may further comprise one or more of Cu: 0.005 to 0.2 weight %, Cr: 0.01 to 0.5 weight %, Ni: 0.05 weight % or less (excluding 0%), and Zn: 0.01 weight % or less (excluding 0%).

The slab may further comprise one or more of Mo: 0.03 weight % or less (excluding 0%), B: 0.0050 weight % or less (excluding 0%), V: 0.0050 weight % or less (excluding 0%), Ca: 0.0050 weight % or less (excluding 0%), Nb: 0.0050 weight % or less (excluding 0%), Zr: 0.005 weight % or less (excluding 0%), Te: 0.01 weight % or less (excluding 0%), Co: 0.05 weight % or less (excluding 0%), and Mg: 0.0050 weight % or less (excluding 0%).

After manufacturing the hot-rolled sheet, subsequent steps can be performed while the scale present on the hot-rolled sheet.

In the preliminary cold rolling step, the reduction rate may be 40 to 79%.

The soaking time in the first soaking step may be 20 to 60 seconds.

After the first soaking step, cooling to the second soaking temperature at a cooling rate of 1 to 20 °C/s may be further included.

The soaking time in the second soaking step may be 40 to 100 seconds.

### Advantageous Effects

An exemplary embodiment of the present disclosure provides a non-oriented electrical steel sheet has an improved texture leading to increased magnetic anisotropy, enabling higher torque to be obtained when manufactured into motors for automobiles.

### MODE FOR INVENTION

The terms such as first, second, and third are used for describing various parts, components, areas, layers, and/or sections, but are not limited thereto. These terms are used only for distinguishing one part, component, area, layer, or section from other parts, components, areas, layers, or sections. Therefore, a first part, component, area, layer, or section described below may be mentioned as a second part, component, area, layer, or section without departing from the scope of the present disclosure.

The terminology used herein is only for mentioning a certain example, and is not intended to limit the present disclosure. Singular forms used herein also include plural forms unless otherwise stated clearly to the contrary. The meaning of “comprising” used in the specification is embodying certain characteristics, areas, integers, steps, operations, elements, and/or components, but is not excluding the presence or addition of other characteristics, areas, integers, steps, operations, elements, and/or components.

In the present specification, when it is mentioned that a part is “on” or “above” the other part, it means that the part is directly on or above the other part or another part may be interposed therebetween. In contrast, when it is mentioned that a part is “directly on” the other part, it means that nothing is interposed therebetween.

In addition, unless otherwise particularly described, % refers to wt %, and 1 ppm refers to 0.0001 wt %.

In an exemplary embodiment of the present disclosure, the meaning of further inclusion of an additional element is replacing iron (Fe) as a remainder by the addition amount.

Though not defined otherwise, all terms including technical terms and scientific terms used herein have the same meaning as commonly understood by a person with ordinary skill in the art to which the present disclosure pertains. Terms defined in commonly used dictionaries are further interpreted as having a meaning consistent with the related technical literatures and the currently disclosed description, and unless otherwise defined, they are not interpreted as having an ideal or very formal meaning.

Hereinafter, an exemplary embodiment of the present disclosure will be described in detail so that a person with ordinary skill in the art to which the present disclosure pertains may easily carry out the present disclosure. As those skilled in the art would realize, the described embodiments may be modified in various different ways, all without departing from the spirit or scope of the present disclosure.

An exemplary embodiment of the present disclosure provides a non-oriented electrical steel sheet comprises, in weight %, Si: 1.5 to 5.0%, Al: 0.1 to 2.0%, Mn: 0.1 to 2.0%, with a remainder of Fe and unavoidable impurities.

Hereinafter, the reason for limiting steel sheet alloy components will be described first.
Si: 1.5 to 5.0 weight %

Silicon (Si) serves to lower iron loss by increasing the resistivity of a material, and enhance strength through high ductility. If too little Si is added, the effects of reducing iron loss and improving strength may be insufficient. If too much Si is added, the brittleness of the material increases, significantly reducing rolling productivity and forming oxidation layers and oxides on the surface that are detrimental to magnetic properties. Therefore, Si can be included in an amount of 1.5 to 5.0 weight %. More specifically, it can be included in an amount of 2.0 to 4.5 weight %, and even more specifically, 2.5 to 4.0 weight %.
Al: 0.1 to 2.0 weight %

Aluminum (Al) serves to lower iron loss by increasing the resistivity of a material, and improve rollability by enhancing workability during cold rolling. If too little Al is added, it may be difficult to achieve high-frequency iron loss reduction effects, and the precipitation temperature of AlN is lowered, leading to the fine formation of nitrides that can degrade magnetic properties. If too much Al is added, excessive formation of nitrides can degrade magnetic properties and cause problems in all processes such as steelmaking and continuous casting, greatly reducing productivity. Therefore, Al can be included in an amount of 0.1 to 2.0 weight %. More specifically, it can be included in an amount of 0.3 to 1.9 weight %, and even more specifically, 0.6 to 1.5 weight %.
Mn: 0.1 to 2.0 weight %

Manganese (Mn) serves to improve iron loss by increasing the resistivity of a material, and form sulfides. If too little Mn is added, fine sulfides can form, causing degradation of magnetic properties, and if too much Mn is added, excessive precipitation of fine MnS can promote the formation of {111} texture unfavorable to magnetic properties, causing a rapid decrease in magnetic flux density. Therefore, Mn can be included in an amount of 0.1 to 2.0 weight %. More specifically, it can be included in an amount of 0.2 to 1.6 weight %, and even more specifically, 0.3 to 1.4 weight %.

The non-oriented electrical steel according to an embodiment of the present invention may further comprise at least one of P: 0.1 weight % or less (excluding 0%), C: 0.005 weight % or less (excluding 0%), S: 0.005 weight % or less (excluding 0%), Ti: 0.005 weight % or less (excluding 0%), N: 0.005 weight % or less (excluding 0%).
P: 0.1 weight % or less

Phosphorus (P) not only increases the resistivity of the material but also, as a grain boundary segregating element, can enhance magnetic flux density. However, if too much P is added, it increases the brittleness of the steel sheet, deteriorating weldability. More specifically, P can be included in an amount of 0.0001 to 0.0500 weight %. Even more specifically, P can be included in an amount of 0.0010 to 0.0200 weight %.
C: 0.005 weight % or less

Carbon (C) can cause magnetic aging and degrade magnetic properties by forming carbides in combination with other impurity elements, hindering grain boundary or magnetic domain movement. More specifically, C can be included in an amount of 0.0001 to 0.003 weight %.
S: 0.005 weight % or less

Sulfur(S) can form fine precipitates such as MnS and CuS, deteriorating magnetic properties and hot workability. More specifically, S can be included in an amount of 0.0001 to 0.0030 weight %.
Ti: 0.005 weight % or less

Titanium (Ti) has a strong tendency to form precipitates in steel, and Ti can degrade iron loss by forming fine carbides, nitrides, or sulfides within the base metal, thereby inhibiting grain growth and magnetic domain movement. More specifically, Ti can be included in an amount of 0.0001 to 0.0030 weight %.
N: 0.005 weight % or less

Nitrogen (N) not only forms fine AlN precipitates within the base metal but also forms fine precipitates by combining with other impurities, inhibiting grain growth and magnetic domain movement, which can degrade iron loss. More specifically, N can be included in an amount of 0.0001 to 0.0030 weight %.

The non-oriented electrical steel according to an embodiment of the present invention may further comprise one or two or more of Sn, Sb, Bi, Pb, Ge, and As, each or in combination, at 0.005 to 0.200 weight %.
Sn

Tin (Sn) serves to segregate to grain boundaries and surfaces to improve the material's microstructure and suppresses surface oxidation, and can be added to enhance magnetic properties. If too much Sn is added, grain boundary segregation becomes severe, degrading surface quality, increasing hardness, causing fractures in cold-rolled sheets, and reducing rollability. Specifically, Sn can be further included in an amount of 0.005 to 0.200 weight %. More specifically, in an amount of 0.010 to 0.080 weight %.
Sb

Antimony (Sb) serves to segregate to grain boundaries and surfaces to improve the material's microstructure and suppress surface oxidation, and can be additionally added to enhance magnetic properties. If too much Sb is added, grain boundary segregation becomes severe, degrading surface quality, increasing hardness, causing fractures in cold-rolled sheets, and reducing rollability. Specifically, Sb can be further included in an amount of 0.005 to 0.200 weight %. More specifically, in an amount of 0.010 to 0.080 weight %.
Bi, Pb, Ge, and As

Bismuth (Bi), Lead (Pb), Germanium (Ge), and Arsenic (As), when additionally added, segregate to grain boundaries to alleviate stress concentration at grain boundaries during cold rolling, thereby suppressing the recrystallization of <111>//ND oriented grains during subsequent annealing, thereby enhancing magnetic flux density. When these elements are appropriately added, additional effects as mentioned above can be obtained. However, if included in too large an amount, excessive segregation can inhibit grain growth, thereby worsening magnetic flux density and iron loss.

The non-oriented electrical steel according to an embodiment of the present invention may further comprise one or more of Cu: 0.005 to 0.2 weight %, Cr: 0.01 to 0.5 weight %, Ni: 0.05 weight % or less (excluding 0%), Zn: 0.01 weight % or less (excluding 0%), and Co: 0.05 weight % or less (excluding 0%).
Cu: 0.005 to 0.200 weight %

Copper (Cu) serves to form sulfides together with Mn. If too little Cu is added, it can result in fine precipitation of (Cu·Mn)S, degrading magnetic properties. If too much Cu is added, hot brittleness occurs, potentially causing soaks during annealing or hot rolling. More specifically, Cu can be included in an amount of 0.01 to 0.10 weight %.
Cr: 0.01 to 0.50 weight %

Chromium (Cr) serves to increase resistivity, improving iron loss. If too little Cr is added, the resistivity enhancement effect may be insufficient. If too much Cr is included, it can decrease magnetic flux density. More specifically, Cr can be included in an amount of 0.050 to 0.20 weight %.
Ni: 0.05 weight % or less

Nickel (Ni) can react with impurity elements to form fine sulfides, carbides, and nitrides that can negatively affect magnetic properties. More specifically, Ni can be included in an amount of 0.001 to 0.03 weight %.
Zn: 0.01 weight % or less

Zinc (Zn), if excessively contained, can act as an impurity and deteriorate magnetic properties. Therefore, Zn can be further added within the aforementioned range. More specifically, Zn can be included in an amount of 0.001 to 0.005 weight %.
Co: 0.05 mass % or less

Cobalt (Co) does not form fine precipitates that reduce magnetic properties but increases high-temperature strength, potentially causing defects in coil shape after hot rolling.

The non-oriented electrical steel according to an embodiment of the present invention may further comprise one or more of Mo: 0.03 weight % or less (excluding 0%), B: 0.0050 weight % or less (excluding 0%), V: 0.0050 weight % or less (excluding 0%), Ca: 0.0050 weight % or less (excluding 0%), Nb: 0.0050 weight % or less (excluding 0%), Zr: 0.005 weight % or less (excluding 0%), Te: 0.01 weight % or less (excluding 0%), and Mg: 0.0050 weight % or less (excluding 0%).
Mo: 0.030 weight % or less

Molybdenum (Mo), if added in excess, can suppress the segregation of element segregating elements, reducing the effect of improving microstructure. Therefore, Mo can be included in an amount of 0.03 weight % or less. The lower limit is not particularly limited, but since it segregates to surfaces and grain boundaries to improve microstructure, it can be included in an amount of 0.001 weight % or more. More specifically, Mo can be included in an amount of 0.001 to 0.010 weight %, and even more specifically, 0.005 to 0.010 weight %.
B: 0.0050 weight % or less

Boron (B), if added in excess, can cause degradation of magnetic properties through the formation of inclusions in steel. Therefore, B can be included in an amount of 0.005 weight % or less. The lower limit is not particularly limited, but due to steelmaking costs, it can be set to 0.0001 weight %. More specifically, B can be included in an amount of 0.0001 to 0.0030 weight %.
V: 0.0050 weight % or less

Vanadium (V) has a very strong tendency to form precipitates in steel, forming fine carbides or nitrides within the base metal, thereby inhibiting grain growth and magnetic domain movement, which can degrade iron loss. Therefore, the V content can be 0.0050 weight % or less. The lower limit is not particularly limited, but due to steelmaking costs, it can be set to 0.0003 weight %. Specifically, V can be included in an amount of 0.0003 to 0.0050 weight %, and even more specifically, 0.0003 to 0.0030 weight %.
Ca: 0.0050 weight % or less

Calcium (Ca) has a very strong tendency to form precipitates in steel, forming fine sulfides within the base metal, thereby inhibiting grain growth and magnetic domain movement, which can degrade iron loss.
Nb: 0.0050 weight % or less

Niobium (Nb) has a very strong tendency to form precipitates in steel, forming fine carbides or nitrides within the base metal, thereby inhibiting grain growth and magnetic domain movement, which can degrade iron loss. Therefore, Nb content can be 0.0050 weight % or less. The lower limit is not particularly limited, but due to steelmaking costs, it can be set to 0.0003 weight %. Specifically, Nb can be included in an amount of 0.0003 to 0.0050 weight %, and even more specifically, 0.0003 to 0.0030 weight %.
Zr: 0.0050 weight % or less

Zirconium (Zr), if added in excess, can cause degradation of magnetic properties through the formation of inclusions in steel. Therefore, Zr can be included in an amount of 0.005 weight % or less. The lower limit is not particularly limited, but due to steelmaking costs, it can be set to 0.0001 weight %. Specifically, Zr can be included in an amount of 0.0001 to 0.0050 weight %, and even more specifically, 0.0005 to 0.0030 weight %.
Te: 0.0100 weight % or less

Tellurium (Te) diffuses into the oxide layer on the surface of hot-rolled coils, increasing the friction coefficient between the oxide layer and rolling work rolls by accumulating beneath the oxide layer, thereby improving hardness. Therefore, it can be added to prevent the crushed oxide layer from being pressed into the base metal and ensuring its detachment during rolling. If the amount of Te added is too small, the effect may be negligible. If too much Te is added, the oxide layer can easily detach, causing the base metal to directly contact the work rolls, reducing the aforementioned effect, and excessive deformation bands can be generated in the steel sheet during cold rolling, leading to the development of {111}//ND oriented grain structures unfavorable to magnetic properties. Specifically, Tellurium can be included in an amount of 0.0001 to 0.007 weight %.
Mg: 0.0050 weight % or less

Magnesium (Mg) primarily combines with S to form sulfides and can affect the surface oxide layer of hot-rolled steel. Therefore, Mg can be included in an amount of 0.0050 weight % or less. The lower limit is not particularly limited, but due to steelmaking costs, it can be set to 0.0001 weight %. Specifically, Mg can be included in an amount of 0.0001 to 0.0050 weight %, and even more specifically, 0.0005 to 0.0030 weight %.

The balance comprises Fe and unavoidable impurities. Unavoidable impurities are impurities mixed during the steelmaking step and the manufacturing processes of non-oriented electrical steel sheets, which are widely known in the field, thus specific descriptions are omitted. In one embodiment of the present invention, adding elements in addition to the aforementioned alloy components is not excluded and can be variously included within the range that does not impair the technical spirit of the present invention. When the additional element is further included, it replaces Fe as the remainder.

As described above, in one embodiment of the present invention, by appropriately adjusting the alloy composition of the steel sheet and annealing through appropriate processes in annealing steps after the preliminary cold rolling, specific grain structures can be developed to maximize magnetic anisotropy.

Specifically, the non-oriented electrical steel sheet according to one embodiment of the present invention satisfies Formula 1 below.

V{001}<001>/V{011}<001>≤0.65 [Equation 1]

(In Equation 1, V{001}<001> represents the fraction of grains with a crystal orientation within 15° of {001}<001>, and V{011}<001> represents the fraction of grains with a crystal orientation within 15° of {011}<001>.)

The {001}<001> texture is the Exact Cube structure, desirable for non-oriented electrical steel sheets, while the {011}<001> texture is the Exact Goss structure, desirable for grain oriented electrical steel sheets. In one embodiment of the present invention, unlike conventional non-oriented electrical steel sheets, the proportion of Exact Cube is lowered compared to Exact Goss to maximize magnetic anisotropy. When the left side value of Equation 1 is small, anisotropy is actually improved. Specifically, the left side value of Formula 1 can be 0.30 to 0.64.

In the embodiment of the present invention, the fraction of textures can be measured by EBSD. Specifically, a sample with an area of 0.5 to 2 mm² of the TD plane of the non-oriented electrical steel sheet is prepared and measured from at least 8 samples.

Also, the non-oriented electrical steel according to an embodiment of the present invention may satisfy the following Equation 2.

(V{100}<001>+V{100}<031>+V{100}<110>)/(V{111}<112>+V{111}<011>)≥1.3 [Equation 2]

{100}<001>, {100}<031>, {100}<110> textures are Rotated Cube textures, favorable for magnetic flux density and iron loss characteristics, and {111}<112>, {111}<011> textures are known as textures unfavorable to magnetic flux density and iron loss. In one embodiment of the present invention, by suppressing the fraction of {111} planes similarly to conventional non-oriented electrical steel sheets, magnetic anisotropy can be maximized. If the left side value of Equation 2 is too small, degradation of magnetic flux density and iron loss may occur. Specifically, the left side value of Equation 2 can be 1.3 to 2.3.

As described above, in one embodiment of the present invention, by developing specific textures, magnetic anisotropy can be maximized. Specifically, the non-oriented electrical steel sheet according to one embodiment of the present invention may satisfy Equation 3 below.

B_{50L}−B_{50D}≥0.08T [Equation 3]

(In Equation 3, B_{50L} represents the magnetic flux density B₅₀ measured in the rolling direction, and B_{50D} represents the magnetic flux density B₅₀ measured in a direction at a 45° angle to the rolling direction.)

Equation 3 represents the difference in magnetic flux density between the rolling direction (RD direction) and the direction at a 45° angle to the rolling direction, and a larger value indicates higher magnetic anisotropy. Specifically, the left side value of Equation 3 can be 0.08 to 0.13 T.

The non-oriented electrical steel according to an embodiment of the present invention may satisfy the following Equation 4.

B_{50C}−B_{50D}≥0.03T [Equation 4]

(In Equation 4, B_{50C} represents the magnetic flux density B₅₀ measured in the direction perpendicular to the rolling direction, and B_{50D} represents the magnetic flux density B₅₀ measured in a direction at a 45° angle to the rolling direction.)

Equation 4 represents the difference in magnetic flux density between the rolling perpendicular direction (TD direction) and the direction at a 45° angle to the rolling direction, and a larger value indicates higher magnetic anisotropy. Specifically, the left side value of Formula 4 can be 0.03 to 0.06 T.

The non-oriented electrical steel according to an embodiment of the present invention may satisfy the following Equation 5.

(B₅₀L+B_{50C})/2≥1.68T [Equation 5]

(In Equation 5, B_{50L} represents the magnetic flux density B₅₀ measured in the rolling direction, and B_{50C} represents the magnetic flux density B₅₀ measured in the direction perpendicular to the rolling direction.)

Equation 5 represents the average of magnetic flux densities in the rolling direction and the rolling perpendicular direction, and a higher value is more favorable. Specifically, the left side value of Formula 5 can be 1.680 to 1.770 T.

As described above, in one embodiment of the present invention, the iron loss (W_{10/400}) of the non-oriented electrical steel sheet is 12.5 W/Kg or less, based on a thickness of 0.25 mm. Iron loss (W_{10/400}) is the iron loss when applying a magnetic flux density of 1.0 T at a frequency of 400 Hz. Specifically, the iron loss (W_{10/400}) of the non-oriented electrical steel sheet can be 10.0 to 12.0 W/kg.

Another exemplary embodiment of the present disclosure provides a method for manufacturing a non-oriented electrical steel sheet including: hot rolling a slab to produce a hot-rolled sheet; preliminarily cold rolling the hot-rolled sheet; first annealing the preliminarily cold-rolled sheet; cold rolling the annealed sheet to produce a cold-rolled sheet; and second annealing the cold-rolled sheet.

Below, each step will be described in detail.

First, the slab is hot rolled.

Since the alloy composition of the slab has been described in the alloy composition of the aforementioned non-oriented electrical steel sheet, redundant descriptions are omitted. Because the alloy composition does not substantially change during the manufacturing process of the non-oriented electrical steel sheet, the alloy composition of the non-oriented electrical steel sheet and the slab are substantially identical.

Specifically, the slab comprises, in weight %, Si: 1.5 to 5.0%, Al: 0.1 to 2.0%, Mn: 0.1 to 2.0%, with a remainder of Fe and unavoidable impurities.

Descriptions of additional elements have been provided in the alloy composition of the non-oriented electrical steel sheet, and therefore redundant descriptions are omitted.

The slab may be heated before hot rolling. The heating temperature of the slab is not limited, but the slab may be heated to 1200 °C or below. If the slab heating temperature is too high, precipitates such as AlN and MnS existing in the slab can be re-dissolved and then finely precipitated during hot rolling and annealing, which may inhibit grain growth and deteriorate magnetic properties.

Next, the slab is hot rolled to produce a hot-rolled sheet. The thickness of the hot-rolled sheet may be 1.0 to 4.5 mm. In the step of producing the hot-rolled sheet, the finishing rolling temperature may be 800 °C or higher. Specifically, it may be 870 to 950 °C. The hot-rolled sheet can be coiled at temperatures of 600 °C or higher. More specifically, the thickness of the hot-rolled sheet may be 1.5 to 4.3 mm.

After producing the hot-rolled steel sheet, subsequent steps can be performed while the scale present on the hot-rolled steel sheet. That is, after hot rolling, scale removal processes such as pickling, shot blasting, or surface grinding may be omitted, and subsequent steps can be performed.

By cold rolling without the pickling process, friction between the rolling work rolls and the steel sheet increases, thereby applying shear deformation in addition to plane deformation during rolling, which leads to the development of specific orientations during recrystallization annealing.

In an embodiment of the present invention, scale refers to portions on the surface of the steel sheet where elements such as Fe, Al, and Si combine with oxygen to form phases different from the base metal. The retention of scale means that at least 1 μm thick scale remains on the hot-rolled sheet.

At this time, the scale thickness refers to the sum of the scale thicknesses formed on both surfaces of the steel sheet. If the residual scale thickness is too thin, the effects due to scale retention may not be sufficiently realized. Even if the scale thickness is thicker, the effect does not improve, and there is the issue of reduced yield of the steel sheet. More specifically, a scale thickness of 0.1 to 1 μm may remain. Additionally, after hot rolling, the steel sheet may be preliminarily cold rolled without externally heating the steel sheet.

Next, the hot-rolled steel sheet is preliminarily cold rolled. Preliminary cold rolling differs from the cold rolling to be described later in that it involves a primary rolling step of rolling to an intermediate thickness, performing intermediate annealing, and then cold rolling to the final product thickness, rather than rolling directly to the final product thickness.

Preliminary cold rolling may be performed within a reduction rate range of 40 to 79% to improve the productivity of final cold rolling and the grain structure in the final product sheet. Additionally, if rolling productivity is not considered, preliminary cold rolling may be performed on a Reverse Mill according to the present invention. The preliminarily cold-rolled sheet may have a thickness of 0.3 to 1.5 mm. More specifically, the reduction rate may be 50 to 75% and the thickness may be 0.6 to 1.3 mm.

The preliminary cold reduction rate can be calculated as (thickness before rolling thickness after rolling)/thickness before rolling×100(%). If the reduction rate in the preliminary cold rolling step is too low, the rolling load increases during final cold rolling, reducing productivity, and the final reduction rate increases, which may promote the recrystallization of fine <111>//ND orientations. Conversely, if the reduction rate is too high, the cold rolling load increases, and the possibility of sheet breakage during rolling also increases.

The preliminary cold rolling step may be performed at a temperature of 60 to 300 °C. This temperature can be elevated either naturally due to the friction between the steel sheet and the rolling rolls or by externally applying heat. If the temperature is too low, the rolling load significantly increases, and the steel sheet may not roll between the rolling rolls but instead slip, causing issues such as twisting. If the temperature is too high, a thick oxide layer may form on the surface of the steel sheet, magnetic properties may deteriorate, and issues such as ignition of the rolling oil may occur. More specifically, it is preferable to perform at a temperature of 70 to 250 °C. The aforementioned temperature refers to the temperature of the steel sheet.

As described above, the preliminary cold rolling step may be omitted if necessary.

Next, in the first annealing step, the preliminarily cold-rolled steel sheet is annealed. In an embodiment of the present invention, through the processes of heating, first soaking, second soaking, and cooling during the first annealing step, a specific texture is developed to maximize magnetic anisotropy.

First, the cold-rolled sheet is heated from 40 °C to the first soaking temperature (T₁) at a rate of 10 to 50 °C/s. If the heating rate is too slow, there is a risk of developing texture with {111} planes. Conversely, if the heating rate is too fast, temperature control becomes difficult, making it hard to control the target sheet temperature. More specifically, heating can be performed at a rate of 15 to 30 °C/s. In an embodiment of the present invention, the temperature referred to is the surface temperature of the steel sheet.

Next, the cold-rolled sheet is soaked at the first soaking temperature (T₁) of 950 to 1100 °C. The first soaking temperature (T₁) is an arbitrarily selected temperature within the range of 950 to 1100 °C, and soaking means maintaining the temperature within +10 °C. If the first soaking temperature (T₁) is too low, issues such as deterioration of iron loss may occur. If the first soaking temperature (T₁) is too high, issues such as deterioration of magnetic flux density and iron loss may occur. More specifically, soaking can be performed at the first soaking temperature (T₁) of 950 to 1050 °C. The soaking time in the first soaking step may be 20 to 60 seconds.

After the first soaking step, the sheet can be cooled to the second soaking temperature at a cooling rate of 1 to 30 °C/s. By appropriately adjusting the cooling rate, residual stress in the steel sheet can be removed. More specifically, the cooling rate can be adjusted to 5 to 20 °C/s.

Next, the cold-rolled sheet is soaked at a second soaking temperature (T₂) of 800 to 950 °C. The second soaking temperature (T₂) is an arbitrarily selected temperature within the range of 800 to 950 °C and may be lower than the first soaking temperature (T₁). By performing soaking in two steps in this manner, it is advantageous in that an appropriate texture is formed while effectively reducing the cooling rate during continuous annealing. If the second soaking temperature (T₂) is too low, the cooling rate between the first and second soaking may increase, leading to residual stresses and deterioration of magnetic properties. If the second soaking temperature (T₂) is too high, there arises the problem of not being able to effectively reduce the cooling rate during cooling. More specifically, soaking can be performed at the second soaking temperature (T₂) of 800 to 950 °C. The soaking time during the second soaking step may be 1 to 30 seconds. More specifically, it may be 5 to 20 seconds.

Next, cooling is performed from the second soaking temperature (T₂) down to 670 °C for 10 to 40 seconds. At this time, if the cooling time is too short, rapid cooling may increase residual stress, leading to deterioration of magnetic properties. Conversely, if the cooling time is too long, TiNb(C,N)-type precipitates may finely precipitate, leading to deterioration of magnetic properties. More specifically, cooling can be performed for 15 to 30 seconds.

Returning to the description of the manufacturing method for the non-oriented electrical steel sheet, after the first annealing step, the annealed steel sheet is cold rolled to produce a cold-rolled sheet.

At this time, cold rolling may be performed with a reduction rate of 55 to 70%. If the reduction rate is too low, the accumulated deformation energy in the rolled steel sheet is small, making recrystallization difficult during the subsequent annealing process, resulting in residual rolled structures and issues in improving magnetic flux density and iron loss. Conversely, if the reduction rate is too high, recrystallization of <111>//ND-oriented grains may be promoted during the subsequent annealing process, and the grain size becomes fine, leading to reduced magnetic flux density and increased iron loss. More specifically, the reduction rate may be 58 to 67%. The cold rolling step can utilize a tandem cold rolling mill that continuously cold rolls the steel sheet using multiple rolling stands or a reverse cold rolling mill that discontinuously cold rolls using twelve or more rolling rolls. The final rolled thickness may be 0.1 mm to 0.35 mm.

Next, in the second annealing step, the cold-rolled sheet is annealed. The second annealing step can be performed at temperatures of 900 °C or higher. If the soaking temperature is too low, grains may not grow sufficiently, resulting in increased hysteresis loss and deterioration of iron loss. More specifically, annealing can be performed at temperatures of 900 to 1050 °C. The second annealing step may involve soaking for 50 to 120 seconds.

During the cold-rolled sheet annealing process, the deformed texture formed during the cold rolling step can all (that is, 99% or more) recrystallize.

After annealing the cold-rolled sheet, an insulating film can be formed. The insulating film may be treated with organic, inorganic, or organic-inorganic composite coatings, and it is also possible to treat it with other insulating coating materials.

Hereinafter, the present disclosure will be described in more detail by the examples. However, the examples are only for illustrating the present disclosure, and the present disclosure is not limited thereto.

### Example 1

Slabs were manufactured using the alloy components shown in Table 1 and Table 2, with a remainder of Fe and other unavoidable impurities. The slabs were heated to 1150 °C and hot rolled at a finishing temperature of 950 °C to produce a hot-rolled sheet with a thickness of 2.3 mm.

Subsequently, the hot-rolled sheet was preliminarily cold rolled with a reduction rate of 65% without annealing, subjected to first annealing under the conditions of Table 3, and then cold rolled to achieve a final thickness of 0.25 mm. The cold-rolled steel sheet was subjected to second annealing under the conditions of Table 3.

The TD plane of the manufactured non-oriented electrical steel sheet was analyzed using EBSD, and the results are presented in Table 4.

The magnetic flux density (B₅₀) and iron loss (W_{10/400}) were measured using the Epstein method for specimens processed to a size of 305 mm×30 mm in the rolling direction, perpendicular to the rolling direction, and at a 45° angle to the rolling direction. The number of turns was adjusted so that the weight of each specimen in the rolling direction, perpendicular direction, and 45° direction was between 400 g and 450 g. In this case, W_{10/400} represents the average of the values measured in the rolling direction and perpendicular direction.

Here, W_{10/400} refers to the iron loss when a magnetic flux density of 1.0 T is applied at a frequency of 400 Hz. B₅₀ represents the magnetic flux density induced in a magnetic field of 5000 A/m.

TABLE 1

| Steel No. | | | | | | |
|---|---|---|---|---|---|---|
| (Weight %) | Si | Al | Mn | P | Sn | Sb |
| 1 | 3.6 | 1.10 | 1.40 | 0.007 | 0.08 | — |
| 2 | 2.9 | 1.40 | 0.20 | 0.004 | 0.08 | 0.02 |
| 3 | 3.8 | 0.60 | 0.70 | 0.007 | 0.05 | 0.03 |
| 4 | 3.3 | 1.70 | 0.10 | 0.006 | 0.03 | 0.04 |
| 5 | 3.5 | 1.00 | 1.00 | 0.009 | — | 0.05 |
| 6 | 3.6 | 1.00 | 0.10 | 0.002 | 0.08 | 0.02 |
| 7 | 3.1 | 1.10 | 1.20 | 0.002 | — | 0.04 |
| 8 | 3.3 | 0.50 | 1.10 | 0.009 | 0.06 | 0.04 |
| 9 | 3.4 | 2.00 | 0.10 | 0.009 | — | 0.04 |
| 10 | 3.3 | 1.30 | 0.20 | 0.004 | 0.06 | — |
| 11 | 3.2 | 2.00 | 0.50 | 0.007 | 0.02 | 0.03 |
| 12 | 3.4 | 1.80 | 0.10 | 0.004 | 0.05 | 0.03 |
| 13 | 3.6 | 0.70 | 1.30 | 0.007 | 0.04 | 0.02 |
| 14 | 3.6 | 0.90 | 0.60 | 0.010 | 0.06 | 0.01 |
| 15 | 3.5 | 1.80 | 1.40 | 0.003 | 0.05 | 0.02 |
| 16 | 2.9 | 1.70 | 0.90 | 0.002 | 0.04 | 0.03 |
| 17 | 1.3 | 0.60 | 0.60 | 0.004 | 0.06 | 0.07 |
| 18 | 5.3 | 1.00 | 0.20 | 0.002 | 0.04 | 0.05 |
| 19 | 3.5 | 0.05 | 0.40 | 0.007 | 0.03 | 0.02 |
| 20 | 3.5 | 2.30 | 0.20 | 0.008 | 0.01 | 0.07 |
| 21 | 3.0 | 1.10 | 0.05 | 0.001 | 0.01 | 0.04 |
| 22 | 3.6 | 1.10 | 2.30 | 0.005 | 0.02 | 0.05 |
| 23 | 2.9 | 1.50 | 1.00 | — | 0.03 | 0.03 |
| 24 | 3.1 | 1.50 | 1.30 | 0.137 | 0.04 | 0.08 |
| 25 | 3.2 | 1.90 | 0.50 | 0.005 | — | 0.01 |
| 26 | 3.2 | 1.70 | 0.50 | 0.009 | 0.10 | 0.03 |
| 27 | 2.7 | 1.30 | 1.30 | 0.003 | 0.03 | — |
| 28 | 2.4 | 2.00 | 1.30 | 0.001 | 0.08 | 0.10 |
| 29 | 3.2 | 1.80 | 1.40 | 0.003 | 0.03 | 0.03 |
| 30 | 3.3 | 0.80 | 0.90 | 0.009 | 0.01 | 0.06 |
| 31 | 3.5 | 1.30 | 0.40 | 0.002 | 0.01 | 0.08 |
| 32 | 2.5 | 2.00 | 1.30 | 0.006 | 0.04 | 0.08 |
| 33 | 3.3 | 1.00 | 0.90 | 0.007 | 0.04 | 0.03 |
| 34 | 3.4 | 1.90 | 0.40 | 0.002 | 0.02 | 0.08 |
| 35 | 2.5 | 1.60 | 1.20 | 0.001 | 0.02 | 0.08 |
| 36 | 2.3 | 1.90 | 0.90 | 0.001 | 0.03 | 0.03 |
| 37 | 3.2 | 1.60 | 0.70 | 0.002 | 0.01 | 0.07 |

TABLE 2

| | | | | | Additional |
|---|---|---|---|---|---|
| | | | | | elements |
| | | | | | (Cr, Cu, Mo, |
| Steel No. | | | | | Bi, Pb, B, V |
| (Weight %) | C | N | S | Ti | etc.) |
| 1 | 0.0010 | 0.0028 | 0.0011 | 0.0023 | — |
| 2 | 0.0022 | 0.0025 | 0.0021 | 0.0028 | Cu 0.020 |
| 3 | 0.0025 | 0.0021 | 0.0028 | 0.0010 | Cu 0.050 |
| 4 | 0.0014 | 0.0016 | 0.0012 | 0.0010 | Zn 0.0005 |
| 5 | 0.0022 | 0.0028 | 0.0025 | 0.0013 | Zn 0.001 |
| 6 | 0.0026 | 0.0010 | 0.0013 | 0.0020 | Co 0.020 |
| 7 | 0.0028 | 0.0010 | 0.0019 | 0.0024 | Ni 0.030 |
| 8 | 0.0029 | 0.0012 | 0.0029 | 0.0010 | Ni 0.050 |
| 9 | 0.0010 | 0.0025 | 0.0011 | 0.0016 | Bi 0.005 |
| 10 | 0.0025 | 0.0014 | 0.0012 | 0.0022 | Bi 0.007 |
| 11 | 0.0023 | 0.0029 | 0.0025 | 0.0012 | Pb 0.005 |
| 12 | 0.0016 | 0.0012 | 0.0029 | 0.0023 | Pb 0.007 |
| 13 | 0.0026 | 0.0023 | 0.0030 | 0.0023 | Ge 0.005 |
| 14 | 0.0026 | 0.0015 | 0.0017 | 0.0026 | Ge 0.007 |
| 15 | 0.0021 | 0.0026 | 0.0029 | 0.0029 | Cr 0.020 |
| 16 | 0.0022 | 0.0015 | 0.0022 | 0.0015 | Cr 0.050 |
| 17 | 0.0029 | 0.0019 | 0.0017 | 0.0029 | — |
| 18 | 0.0019 | 0.0026 | 0.0013 | 0.0030 | — |
| 19 | 0.0028 | 0.0028 | 0.0029 | 0.0023 | — |
| 20 | 0.0023 | 0.0021 | 0.0020 | 0.0025 | — |
| 21 | 0.0024 | 0.0026 | 0.0012 | 0.0027 | — |
| 22 | 0.0011 | 0.0030 | 0.0016 | 0.0023 | — |
| 23 | 0.0012 | 0.0025 | 0.0022 | 0.0014 | — |
| 24 | 0.0017 | 0.0020 | 0.0025 | 0.0019 | — |
| 25 | 0.0026 | 0.0024 | 0.0021 | 0.0019 | — |
| 26 | 0.0020 | 0.0021 | 0.0023 | 0.0022 | — |
| 27 | 0.0027 | 0.0020 | 0.0017 | 0.0028 | — |
| 28 | 0.0020 | 0.0020 | 0.0011 | 0.0029 | — |
| 29 | 0.0011 | 0.0011 | 0.0019 | 0.0010 | — |
| 30 | 0.0028 | 0.0025 | 0.0020 | 0.0012 | — |
| 31 | 0.0022 | 0.0021 | 0.0018 | 0.0018 | — |
| 32 | 0.0022 | 0.0011 | 0.0029 | 0.0015 | — |
| 33 | 0.0018 | 0.0013 | 0.0011 | 0.0028 | — |
| 34 | 0.0023 | 0.0022 | 0.0021 | 0.0021 | — |
| 35 | 0.0017 | 0.0020 | 0.0021 | 0.0023 | — |
| 36 | 0.0027 | 0.0021 | 0.0010 | 0.0011 | — |
| 37 | 0.0011 | 0.0016 | 0.0020 | 0.0011 | — |

TABLE 3

| | | | Cooling rate | second | |
|---|---|---|---|---|---|
| | Heating | First soaking | after the first | soaking | |
| Steel | rate | temperature | soaking step | temperature | cooling time |
| No. | (°C/s) | (°C) | (°C/s) | (°C) | (second) |
| 1 | 24 | 1030 | 13 | 910 | 40 |
| 2 | 21 | 1030 | 12 | 880 | 28 |
| 3 | 20 | 1050 | 15 | 850 | 25 |
| 4 | 18 | 1030 | 3 | 910 | 30 |
| 5 | 33 | 1050 | 15 | 890 | 23 |
| 6 | 21 | 970 | 9 | 810 | 13 |
| 7 | 23 | 1040 | 3 | 870 | 33 |
| 8 | 47 | 1050 | 12 | 900 | 23 |
| 9 | 34 | 1050 | 3 | 950 | 13 |
| 10 | 41 | 1030 | 13 | 820 | 19 |
| 11 | 40 | 970 | 10 | 850 | 33 |
| 12 | 34 | 1000 | 5 | 890 | 22 |
| 13 | 37 | 950 | 20 | 930 | 11 |
| 14 | 45 | 1010 | 18 | 950 | 21 |
| 15 | 44 | 1040 | 18 | 840 | 22 |
| 16 | 32 | 1000 | 9 | 880 | 25 |
| 17 | 31 | 1080 | 19 | 930 | 24 |
| 18 | | | Cold rolling impossible | | |
| 19 | 12 | 1090 | 17 | 850 | 25 |
| 20 | | | Cold rolling impossible | | |
| 21 | 28 | 1020 | 12 | 870 | 39 |
| 22 | | | Cold rolling impossible | | |
| 23 | 22 | 950 | 15 | 910 | 10 |
| 24 | 29 | 1030 | 5 | 940 | 25 |
| 25 | 23 | 970 | 18 | 940 | 27 |
| 26 | 23 | 990 | 3 | 890 | 37 |
| 27 | 32 | 1030 | 6 | 810 | 18 |
| 28 | 36 | 950 | 4 | 890 | 39 |
| 29 | 5 | 1010 | 13 | 800 | 14 |
| 30 | 70 | 1060 | 19 | 880 | 10 |
| 31 | 12 | 900 | 2 | 820 | 26 |
| 32 | 10 | 1150 | 18 | 850 | 14 |
| 33 | 13 | 1100 | 30 | 880 | 15 |
| 34 | 13 | 1070 | 16 | 770 | 13 |
| 35 | 48 | 980 | 6 | 980 | 25 |
| 36 | 17 | 1040 | 2 | 820 | 5 |
| 37 | 46 | 1080 | 2 | 940 | 50 |

TABLE 4

| Steel | Value of | Value of | | | |
|---|---|---|---|---|---|
| No. | Equation 1 | Equation 2 | B50L(Tesla) | B50C(Tesla) | B50D(Tesla) |
| 1 | 0.58 | 1.8 | 1.74 | 1.67 | 1.62 |
| 2 | 0.49 | 1.5 | 1.77 | 1.71 | 1.67 |
| 3 | 0.53 | 1.6 | 1.77 | 1.71 | 1.66 |
| 4 | 0.38 | 1.4 | 1.74 | 1.67 | 1.64 |
| 5 | 0.61 | 1.7 | 1.75 | 1.66 | 1.62 |
| 6 | 0.51 | 1.8 | 1.76 | 1.68 | 1.65 |
| 7 | 0.54 | 1.5 | 1.76 | 1.68 | 1.65 |
| 8 | 0.64 | 1.3 | 1.78 | 1.70 | 1.66 |
| 9 | 0.55 | 1.6 | 1.72 | 1.66 | 1.62 |
| 10 | 0.49 | 1.6 | 1.76 | 1.69 | 1.66 |
| 11 | 0.57 | 1.9 | 1.72 | 1.67 | 1.63 |
| 12 | 0.60 | 2.1 | 1.73 | 1.67 | 1.64 |
| 13 | 0.62 | 1.4 | 1.76 | 1.69 | 1.65 |
| 14 | 0.58 | 2.0 | 1.76 | 1.70 | 1.66 |
| 15 | 0.46 | 1.8 | 1.70 | 1.63 | 1.59 |
| 16 | 0.38 | 1.9 | 1.74 | 1.65 | 1.62 |
| 17 | 0.72 | 1.1 | 1.80 | 1.72 | 1.74 |
| 18 | | | Cold rolling impossible | | |
| 19 | 0.82 | 0.8 | 1.76 | 1.64 | 1.69 |
| 20 | | | Cold rolling impossible | | |
| 21 | 0.72 | 0.7 | 1.65 | 1.61 | 1.59 |
| 22 | | | Cold rolling impossible | | |
| 23 | 0.60 | 1.3 | 1.72 | 1.67 | 1.64 |
| 24 | 0.55 | 1.5 | 1.71 | 1.66 | 1.63 |
| 25 | 0.59 | 1.5 | 1.71 | 1.65 | 1.62 |
| 26 | 0.61 | 1.4 | 1.71 | 1.66 | 1.63 |
| 27 | 0.58 | 1.6 | 1.72 | 1.66 | 1.63 |
| 28 | 0.63 | 1.5 | 1.71 | 1.65 | 1.62 |
| 29 | 0.50 | 0.4 | 1.65 | 1.60 | 1.59 |
| 30 | 1.20 | 1.4 | 1.66 | 1.62 | 1.59 |
| 31 | 0.80 | 1.4 | 1.63 | 1.59 | 1.59 |
| 32 | 1.20 | 0.5 | 1.61 | 1.55 | 1.55 |
| 33 | 0.56 | 1.5 | 1.71 | 1.67 | 1.63 |
| 34 | 0.50 | 1.2 | 1.70 | 1.63 | 1.60 |
| 35 | 0.48 | 1.1 | 1.69 | 1.63 | 1.63 |
| 36 | 0.50 | 1.2 | 1.69 | 1.63 | 1.60 |
| 37 | 0.60 | 1.1 | 1.68 | 1.62 | 1.59 |

TABLE 5

| | Value | Value | Value | Iron | |
|---|---|---|---|---|---|
| | of | of | of | loss | |
| Steel | Equa- | Equa- | Equa- | W10/400 | |
| No. | tion 3 | tion 4 | tion 5 | (W/kg) | Remarks |
| 1 | 0.12 | 0.05 | 1.705 | 10.8 | Example |
| 2 | 0.10 | 0.04 | 1.740 | 11.7 | Example |
| 3 | 0.11 | 0.05 | 1.740 | 11.9 | Example |
| 4 | 0.10 | 0.03 | 1.705 | 11.9 | Example |
| 5 | 0.13 | 0.04 | 1.705 | 12.0 | Example |
| 6 | 0.11 | 0.03 | 1.720 | 11.7 | Example |
| 7 | 0.11 | 0.03 | 1.720 | 11.8 | Example |
| 8 | 0.12 | 0.04 | 1.740 | 11.9 | Example |
| 9 | 0.10 | 0.04 | 1.690 | 11.5 | Example |
| 10 | 0.10 | 0.03 | 1.725 | 11.7 | Example |
| 11 | 0.09 | 0.04 | 1.695 | 10.9 | Example |
| 12 | 0.09 | 0.03 | 1.700 | 11.3 | Example |
| 13 | 0.11 | 0.04 | 1.725 | 11.5 | Example |
| 14 | 0.10 | 0.04 | 1.730 | 11.0 | Example |
| 15 | 0.11 | 0.04 | 1.665 | 11.4 | Example |
| 16 | 0.12 | 0.03 | 1.695 | 11.5 | Example |
| 17 | 0.06 | −0.02 | 1.760 | 18.7 | Comparative Example |
| 18 | Cold rolling impossible | | | | Comparative Example |
| 19 | 0.07 | −0.05 | 1.700 | 14.2 | Comparative Example |
| 20 | Cold rolling impossible | | | | Comparative Example |
| 21 | 0.06 | 0.02 | 1.630 | 13.2 | Comparative Example |
| 22 | Cold rolling impossible | | | | Comparative Example |
| 23 | 0.08 | 0.03 | 1.695 | 11.80 | Example |
| 24 | 0.08 | 0.03 | 1.685 | 12.10 | Example |
| 25 | 0.09 | 0.03 | 1.680 | 12.30 | Example |
| 26 | 0.08 | 0.03 | 1.685 | 11.80 | Example |
| 27 | 0.09 | 0.03 | 1.690 | 12.00 | Example |
| 28 | 0.09 | 0.03 | 1.680 | 11.70 | Example |
| 29 | 0.06 | 0.01 | 1.625 | 12.20 | Comparative Example |
| 30 | 0.07 | 0.03 | 1.640 | 12.60 | Comparative Example |
| 31 | 0.04 | 0.00 | 1.610 | 12.80 | Comparative Example |
| 32 | 0.06 | 0.00 | 1.580 | 12.10 | Comparative Example |
| 33 | 0.08 | 0.04 | 1.690 | 12.10 | Example |
| 34 | 0.10 | 0.03 | 1.665 | 12.50 | Comparative Example |
| 35 | 0.06 | 0.00 | 1.660 | 13.90 | Comparative Example |
| 36 | 0.09 | 0.03 | 1.660 | 12.70 | Comparative Example |
| 37 | 0.09 | 0.03 | 1.650 | 12.60 | Comparative Example |

As shown in Table 1 to Table 5, when the steel alloy is properly adjusted and the process conditions are appropriately controlled, resulting in a suitably texture, the invention exhibits excellent iron loss and magnetic flux density while simultaneously maximizing magnetic anisotropy.

Conversely, when the steel alloy is not properly adjusted or the process conditions are inadequately controlled, leading to an improperly formed texture, it can be confirmed that iron loss and magnetic flux density are inferior, and sufficient magnetic anisotropy cannot be achieved.

The present disclosure is not limited by the above exemplary embodiments and may be manufactured in various forms different from each other, and it may be understood that a person with ordinary skill in the art to which the present disclosure pertains may carry out the present disclosure in another specific form without modifying the technical idea or essential feature of the present disclosure. Therefore, it should be understood that the exemplary embodiments described above are illustrative and are not restrictive in all aspects.

1. A non-oriented electrical steel sheet comprising, in weight %, Si: 1.5 to 5.0%, Al: 0.1 to 2.0%, Mn: 0.1 to 2.0%, with a remainder of Fe and unavoidable impurities, and satisfies the following Equation 1.
V{001}<001>/V{011}<001>≤0.65 [Equation 1]
(In Equation 1, V{001}<001> represents the fraction of grains with a crystal orientation within 15° of {001}<001>, and V{011}<001> represents the fraction of grains with a crystal orientation within 15° of {011}<001>.)

2. The non-oriented electrical steel sheet of claim 1, wherein:
the non-oriented electrical steel satisfies the following Equation 2.
(V{100}<001>+V{100}<031>+V{100}<110>)/(V{111}<112>+V{111}<011>)≥1.3 [Equation 2]
(In Equation 2, V{100}<001> represents the fraction of grains with a crystal orientation within 15° of {100}<001>, V{100}<031> represents the fraction of grains with a crystal orientation within 15° of {100}<031>, V{100}<110> represents the fraction of grains with a crystal orientation within 15° of {100}<110>, V{111}<112> represents the fraction of grains with a crystal orientation within 15° of {111}<112>, and V{111}<011> represents the fraction of grains with a crystal orientation within 15° of {111}<011>.)

3. The non-oriented electrical steel sheet of claim 1, wherein:
the non-oriented electrical steel further comprises at least one of P: 0.1 weight % or less (excluding 0%), C: 0.005 weight % or less (excluding 0%), S: 0.005 weight % or less (excluding 0%), Ti: 0.005 weight % or less (excluding 0%), N: 0.005 weight % or less (excluding 0%).

4. The non-oriented electrical steel sheet of claim 1, wherein:
the non-oriented electrical steel further comprises one or two or more of Sn, Sb, Bi, Pb, Ge, and As, each or in combination, at 0.005 to 0.200 weight %.

5. The non-oriented electrical steel sheet of claim 1, wherein:
the non-oriented electrical steel further comprises one or more of Cu: 0.005 to 0.2 weight %, Cr: 0.01 to 0.5 weight %, Ni: 0.05 weight % or less (excluding 0%), Zn: 0.01 weight % or less (excluding 0%), and Co: 0.05 weight % or less (excluding 0%).

6. The non-oriented electrical steel sheet of claim 1, wherein:
the non-oriented electrical steel further comprises one or more of Mo: 0.03 weight % or less (excluding 0%), B: 0.0050 weight % or less (excluding 0%), V: 0.0050 weight % or less (excluding 0%), Ca: 0.0050 weight % or less (excluding 0%), Nb: 0.0050 weight % or less (excluding 0%), Zr: 0.005 weight % or less (excluding 0%), Te: 0.01 weight % or less (excluding 0%), and Mg: 0.0050 weight % or less (excluding 0%).

7. The non-oriented electrical steel sheet of claim 1, wherein:
the non-oriented electrical steel satisfies the following Equation 3.
B_{50L}−B_{50D}≥0.08T [Equation 3]
(In Equation 3, B_{50L} represents the magnetic flux density B₅₀ measured in the rolling direction, and B_{50D} represents the magnetic flux density B₅₀ measured in a direction at a 45° angle to the rolling direction.)

8. The non-oriented electrical steel sheet of claim 1, wherein:
the non-oriented electrical steel satisfies the following Equation 4.
B_{50C}−B_{50D}≥0.03 T [Equation 4]
(In Equation 4, B_{50C} represents the magnetic flux density B₅₀ measured in the direction perpendicular to the rolling direction, and B_{50D} represents the magnetic flux density B₅₀ measured in a direction at a 45° angle to the rolling direction.)

9. The non-oriented electrical steel sheet of claim 1, wherein:
the non-oriented electrical steel satisfies the following Equation 5.
(B_{50L}+B_{50C})/2≥1.68T [Equation 5]
(In Equation 5, B_{50L} represents the magnetic flux density B₅₀ measured in the rolling direction, and B_{50C} represents the magnetic flux density B₅₀ measured in the direction perpendicular to the rolling direction.)

10. A method for manufacturing a non-oriented electrical steel sheet, the method comprising:
hot rolling a slab comprising, in weight %, Si: 1.5 to 5.0%, Al: 0.1 to 2.0%, Mn: 0.1 to 2.0%, with a remainder of Fe and unavoidable impurities to produce a hot-rolled sheet;
preliminarily cold rolling the hot-rolled sheet;
first annealing the preliminarily cold-rolled sheet;
cold rolling the annealed sheet to produce a cold-rolled sheet; and
second annealing the cold-rolled sheet,
wherein the first annealing step includes heating the cold-rolled sheet from 40 °C to a first soaking temperature (T₁) at a rate of 10 to 50 °C/s;
first soaking the cold-rolled sheet at the first soaking temperature (T₁) of 950 to 1100 °C;
second soaking the cold-rolled sheet at a second soaking temperature (T₂) of 800 to 950 °C; and
cooling from the second soaking temperature (T₂) to 670 °C for 10 to 40 seconds.

11. The method for manufacturing a non-oriented electrical steel sheet of claim 10, wherein:
the slab further comprises at least one of P: 0.1 weight % or less (excluding 0%), C: 0.005 weight % or less (excluding 0%), S: 0.005 weight % or less (excluding 0%), Ti: 0.005 weight % or less (excluding 0%), and N: 0.005 weight % or less (excluding 0%).

12. The method for manufacturing a non-oriented electrical steel sheet of claim 10, wherein:
the slab further comprises one or two or more of Sn, Sb, Bi, Pb, Ge, and As, each or in combination, at 0.005 to 0.200 weight %.

13. The method for manufacturing a non-oriented electrical steel sheet of claim 10, wherein:
the slab further comprises one or more of Cu: 0.005 to 0.2 weight %, Cr: 0.01 to 0.5 weight %, Ni: 0.05 weight % or less (excluding 0%), Zn: 0.01 weight % or less (excluding 0%), Co: 0.05 weight % or less (excluding 0%).

14. The method for manufacturing a non-oriented electrical steel sheet of claim 10, wherein:
the slab further comprises one or more of Mo: 0.03 weight % or less (excluding 0%), B: 0.0050 weight % or less (excluding 0%), V: 0.0050 weight % or less (excluding 0%), Ca: 0.0050 weight % or less (excluding 0%), Nb: 0.0050 weight % or less (excluding 0%), Zr: 0.005 weight % or less (excluding 0%), Te: 0.01 weight % or less (excluding 0%), and Mg: 0.0050 weight % or less (excluding 0%).

15. The method for manufacturing a non-oriented electrical steel sheet of claim 10, wherein:
after manufacturing the hot-rolled sheet, subsequent steps are performed while the scale present on the hot-rolled sheet.

16. The method for manufacturing a non-oriented electrical steel sheet of claim 10, wherein:
in the preliminary cold rolling step, the reduction rate is 40 to 79%.

17. The method for manufacturing a non-oriented electrical steel sheet of claim 10, wherein:
the soaking time in the first soaking step is 20 to 60 seconds

18. The method for manufacturing a non-oriented electrical steel sheet of claim 10, wherein:
after the first soaking step, cooling to the second soaking temperature at a cooling rate of 1 to 20 °C/s is further included.

19. The method for manufacturing a non-oriented electrical steel sheet of claim 10, wherein:
the soaking time in the second soaking step is 40 to 100 seconds.
